(19) United States
(12) Patent Application Publication
(10) Pub. No.: US 2026/0001714 A1
(43) Pub. Date: Jan. 1, 2026

(54) Tractor-Attachable, Multi-Purpose Waste Receptacle

(71) Applicant: Jason Lovett, Griffin, GA (US)

(72) Inventor: Jason Lovett, Griffin, GA (US)

(21) Appl. No.: 18/757,073

(22) Filed: Jun. 27, 2024

(51) Int. Cl. B65F 1/14; B65F 1/02; B65F 1/16

(52) U.S. Cl. CPC B65F 1/1452; B65F 1/02; B65F 1/16

(57) ABSTRACT

The disclosed inventive concept, referred to as a multi-purpose waste receptacle, is constructed of metal, fiberglass, PVC, or other sturdy, adequately strengthened material. The basic design is a rectangular-shaped box/container having an interior volume defined by four interconnected upright walls, integrally attached to a planar floor. The waste receptacle features one or more pivotable lids. Each lid is pivotably attached to a widthwise retaining rod atop a rear wall. When lids are closed, they are oriented parallel to, and in abutment to the tops of the four upright walls. A width-wide bottommost front rake is utilized to disperse and/or distribute any waste or other content having been emptied from the waste receptacle. Integral embodiments of an attachment mechanism enable temporary securement of the rear outer wall of the waste receptacle to a tractor boom, loader, or other mechanical lifting vehicle.

### CROSS-REFERENCES TO RELATED APPLICATIONS

This patent application claims the benefit and priority of the content of previously-filed U.S. provisional patent application, Ser. No. 63/523,879, filed on Jun. 28, 2023, as though said provisional patent application appears fully herein.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The field of the present inventive concept relates generally to methods and equipment utilized to operate and/or transport an industrial trash or waste receptacle in varying scenarios and conditions. More particularly, this invention relates to a multi-use waste receptacle device which is constructed with an attachment mechanism so as to enable detachable securement of the waste receptacle to a tractor boom or other mechanical lifting vehicle.

For purposes of this inventive concept, the attachment mechanism comprises at least two different embodiments of a means for connection of the waste receptacle to the tractor, loader, or mechanical lifting vehicle. another specific function, but not by way of limitation, is utilization of a horizontal rake component of the multi-waste receptacle for spreading and/or leveling its waste or manure content onto a selected area of ground so as to provide fertilization or form compost.

### (2) Description of the Related Art, Including Information Disclosed Under 37 CFR 1.97 and 1.98

U.S. Pat. No. 38,944,742 B2; Feb. 3, 2015; C. Hill

A trash receptacle mover including a first quick-attach assembly secured to an off-road vehicle and second quick-attach assembly connected to a trash receptacle attachment member. The quick-attach assemblies may be selectively connected together. The trash receptacle attachment member may be secured to a recessed bar on the trash receptacle so that the trash receptacle may be lifted from the ground and transported to a distant location.

### U.S. Published Patent Application #2006/00792993 AI; Apr. 6, 2006; M. Stragier

A refuse disposal system includes a relatively small refuse collection truck including a chassis and a hopper, including a packer, for receiving refuse. A body has a bottom, side walls, and a cover and defines an opening in a side wall. The chassis includes detachment and manipulation apparatus with the body being detachably mounted on the detachment and manipulation apparatus in communication with the opening for moving refuse thereto with the body in a collecting position. The detachment and manipulation apparatus is designed to move the body from the collecting position to a hauling position and to detach the body in the hauling position. A relatively large haul vehicle has a chassis with a plurality of body receiving frames mounted thereon positioned to receive the body from the collecting truck when the body is moved by the detachment and manipulation apparatus from the collecting position.

U.S. Pat. No. 11,801,996 B2; Frank Yang et al; Oct. 31, 2023;

Various trash can assembly embodiments are disclosed. In some embodiments, the trash can assembly includes a body and a lid assembly. The lid assembly can include a lid, and a multicomponent trim ring. The lid assembly can be rotatably connected with the body via a hinge unit. In certain embodiments, a flange of the trim ring is guided into and/or received into the hinge unit. A translating pin of the hinge unit can engage into the flange, thereby providing a rotatable connection between the trim ring and the body. In various embodiments, the translating pin is coupled with a handle to facilitate movement of the pin by a user during engagement of the trim ring and the hinge unit. A positioner can help to position the trash can against or adjacent to a wall or other structure. The movement of both the trim ring and the lid can be dampened.

U.S. Pat. No. 9,561,904 B1; Osborn, W. Feb. 7, 2017

A multi-purpose dumping device mounted on one vehicle assists with the emptying of both a heavy commercial refuse container and a lighter residential refuse container and easily operable by the current vehicle structure without substantial modification to the tipping mechanism.

### (3) Background Information

In rural areas, residents who own horse stables, barns, or sheltered overhead buildings for livestock must periodically pick up the manure regularly dropped by these animals onto the floor of the building or onto a ground wall. This manure must often, or desirably, be moved to a different area or remote location. A certain type of trash receptacle may be used, or even hand tools such as shovels, rakes, picks, etc. to gather the manure, and then eventually, carry the waste receptacle to be disbursed in a certain area. This area may be a side road, grassy field, or dumping area which is some distance from the residence or stables.

The user of the waste receptacle must then either roll, drag, or push the waste receptacle to the point of disbursement or load the same onto a truck or tractor and then haul the waste receptacle to a point of disbursement. When the manure or trash has been deposited or dumped, the resident must then recover the empty waste receptacle from the point of emptying by rolling, pushing, or dragging the same back near the residence or stables. The user may also have the option of hauling the waste receptacle back to the residence or stables with a truck or tractor. Since most trash or waste receptacles used in rural areas are often quite large, the task of taking animal manure to a disbursement area and then retrieving the receptacle and returning it to the area of the stables can be quite burdensome.

It is the objective of the disclosed inventive concept to provide a quick, efficient means of (a) utilizing a functional waste receptacle for gathering manure or waste from stables or livestock areas, (b) transporting the waste receptacle and its accumulated waste or other material to a separate, isolated area, and (3) returning the waste receptacle to its normal storage location.

### BRIEF SUMMARY OF THE INVENTION

The disclosed inventive concept is referred to as a multi-purpose waste receptacle 1, and may be constructed of metal, fiberglass, PVC, or other sturdy, adequately strengthened material. The waste receptacle 1 is essentially constructed as a rectangular-shaped box-container having an interior volume defined by four interconnected upright walls 2, 3, 4, 5, integral to a bottom wall, or floor 7. The waste receptacle features two separate lids 8, 9, each being pivotably attached to a rear ledge 20 atop the rear wall 4. When both lids 8, 9 are closed, they are oriented parallel to, and in abutment to the tops of the four upright walls 2, 3, 4, 5.

A significant feature of the waste receptacle 1 is a horizontally-oriented rake 10, which extends the width of the lower front wall 2(a). The rake 10 provides a means for spreading and/or parceling soil-enhancing materials that may be transported by the waste receptacle 1. In the preferred embodiment of the waste receptacle 1, the outer wall 4(a) of the rear wall 4 is constructed having a permanently-attached S-brackets 23, 27. Each S-bracket 23, 27 is constructed having an outwardly curvilinear bend 24, 28, at its uppermost extent, respectively.

The S-brackets 23, 27 form an attachment mechanism which allows simultaneous detachable fitting onto a specially-made connector 33, commonly referred to as a “skid steer.” Connectors of this type are common in the industry and are made by manufacturers such as John Deere®, Kubota®, Bobcat®, and others.

### BRIEF DESCRIPTION OF THE VIEWS OF THE DRAWINGS, AS EXEMPLARY EMBODIMENTS OF THE INVENTIVE CONCEPT

FIG. 1 illustrates a frontal view of the entirety of a waste receptacle 1 having two pivotable tops. The view further shows the front wall 2, several structural ribs 17, 18, and a horizontally-oriented rake 10.

FIG. 1A shows an isometric view of the top and front of the waste receptacle 1, with both pivotable lids 8, 9 having been removed, further showing the rake 10 attached between the left front stanchion 11 and the right front stanchion 12.

FIG. 2 depicts a rear view of the waste receptacle 1, including the arrangement of structural ribs 17, 18, the rear ledge 20, the rear stanchions 21, 22, and two identical S-brackets, 23, 27.

FIG. 2A is a view of the waste receptacle 1 with the pivotable lids 8, 9 removed. The left and right S-brackets 23, 27 are shown, which coordinate with a John Deere© S-hook connector.

FIG. 3 illustrates a different embodiment of the waste receptacle 1, having a detachable attachment mechanism. Further shown on the rear outer wall 4(a) are a right vertical brace 37 and a left vertical brace 38.

FIG. 4 presents a view of the left outer wall 3(a) of the waste receptacle 1, having both pivotable lids 8, 9, closed.

FIG. 5 displays a left side view of the waste receptacle 1, showing the left outer wall 3(a), with both pivotable lids 8, 9 open, and a partial view of the left S-bracket 23.

FIG. 6 displays the waste receptacle 1, containing waste, having been latched onto by the boom 32 of a tractor 31 and lifted, vertically, for transport by the tractor 31.

FIG. 7 illustrates the waste receptacle 1, securely attached to the tractor boom 32 having been tilted downward, causing the emptying of its waste 36 contents.

FIG. 8 shows the tractor boom 32 actively positioning the waste receptacle 1 so as to engage its widthwise rake 10 in the process of spreading and/or distributing the load of waste 36.

Table of Nomenclature & Part Numbers of Invention

1. Waste receptacle
2. Front wall
2(a) Front outer wall
2(b) Front inner wall
2(c) Front bottom edge
3. Left wall
3(a) left outer wall
3(b) Left inner wall
3(c) Left bottom edge
4. Rear wall
4(a) Rear outer wall
4(b) Rear inner wall
4(c) Rear bottom edge
5. Right wall
5(a) Right outer wall
5(b) Right inner wall
5(c) Right bottom edge
6. Bottom outer wall
7. Floor
8. Left pivotable lid
9. Right pivotable lid
10. Rake
11. Left front stanchion
12. Right front stanchion
13. Left retainer lug
13(a) Orifice
14. Right retainer lug
14(a) Orifice
15. Center retainer lug
15(a) Orifice
16. Retaining rod
17. Contoured rib
18. Straight rib
19. Front ledge
20. Rear ledge
21. Left rear stanchion
22. Right rear stanchion
23. Left S-bracket
24. Left curvilinear bend
25. Left upper fastener
26. Left lower fastener
27. Right S-bracket
28. Right curvilinear bend
29. Right upper fastener
30. Right lower fastener
31. Tractor
32. Front boom
33. Connector
34. Alignment/attachment pin
35. Beam
36. Waste
37. Right vertical brace
38. Left vertical brace
39. Ground surface
40. Slot

### DETAILED DESCRIPTION OF THE INVENTION

The objects, features, and advantages of the inventive concept presented in this application are more readily understood when referring to the accompanying drawings. The drawings, totaling ten figures, show the basic components and functions of embodiments and/or methods of use. In the several figures, like reference numbers are used in each figure to correspond to the same component as may be depicted in other figures.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

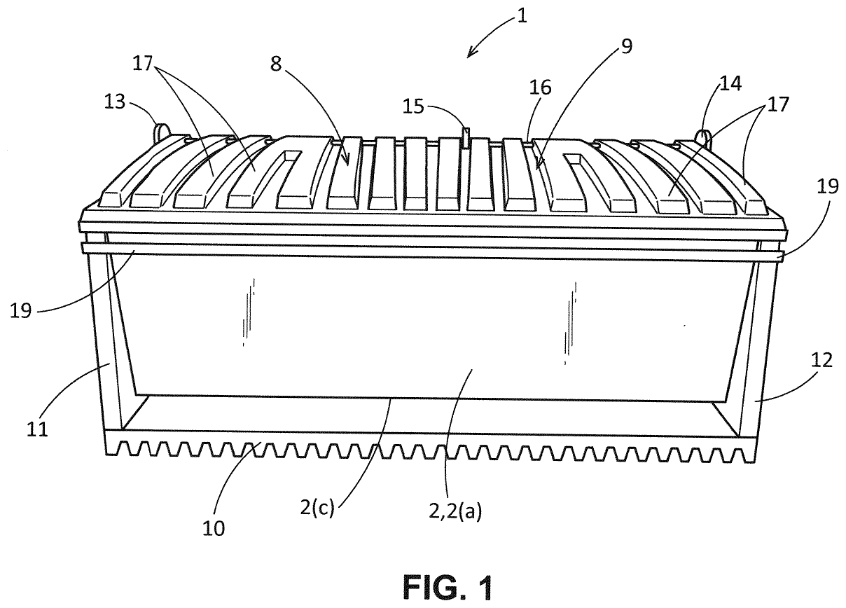

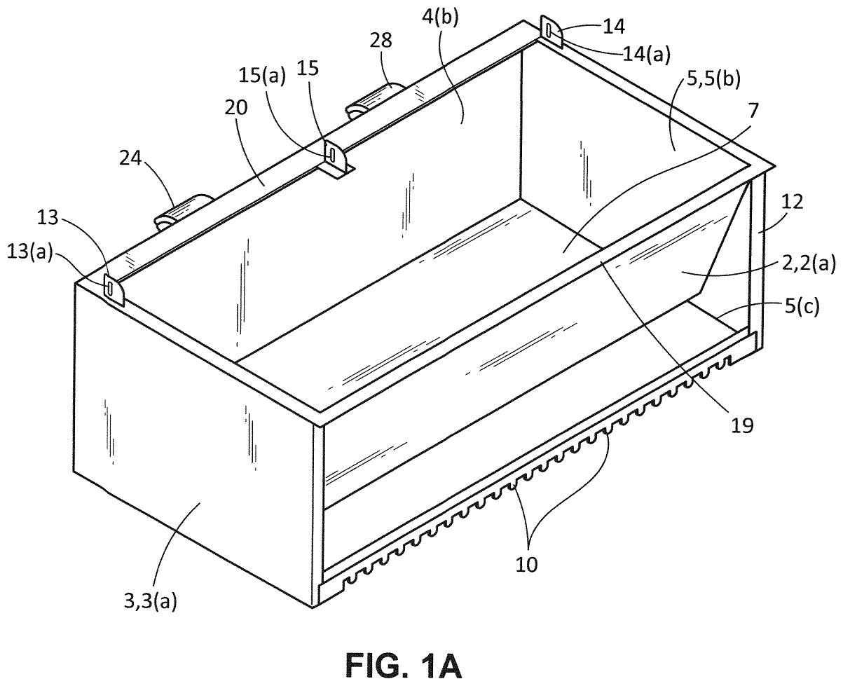

The discussion of the present inventive concept will be initiated with FIG. 1. There is illustrated, in FIG. 1, a frontal view of the entirety of the waste receptacle 1. Functional components shown are a front wall 2, including its outer surface 2(a), and a series of contoured, parallel structural ribs 17 forming a left pivotable lid 8 and right pivotable lid 9. Further shown are a front ledge 19, a left front stanchion 11, a right front stanchion 12, and a horizontally-oriented rake 10. The front stanchions 11, 12 are formed as a result of the frontward extension of the left wall 3 and right wall 5, respectively.

It is to be noted, in FIG. 1, that the front wall 2 is slanted rearward from its top edge to its bottom edge in order to facilitate emptying of any content of the waste receptacle 1 when the front wall 2 of the waste receptacle 2 is uplifted and tilted downward. Further shown in FIG. 1 is a horizontally-oriented rake 10 which extends the width of the waste receptacle 1, being attached to the lowest portions of the front stanchions 11, 12. The rake 10 may be utilized by an operator of the waste receptacle 1 in conjunction with spreading or distributing any materials that may have been dumped from the waste receptacle 1.

Also, partially visible in FIG. 1 as a retaining rod 16 secured through concentric orifices in each, a left retainer lug 13, a center retainer lug 15 and a right retainer lug 14. The regaining rod 16 serves to retain the rear ends of the two pivotable lids 8, 9 as the two lids 8, 9 rotate from an open position to a closed position and vice versa.

In FIG. 1A, there is presented a frontal view of the waste receptacle 1 with both the left pivotable lid 8 and the right pivotable lid 9 having been removed. Further shown is the rake 10 horizontally attached between the left front stanchion 11 and the right front stanchion 12. The left retainer lug 13, center retainer lug 15, and right retainer lug 14 provide support for the retaining rod 16 (not shown) which retaining rod 16 fits within concentric orifices 13(a), 15(a), 14(a). The planar floor 7 of the waste receptacle 1 is further visible, along with the inner surface 4(b) of the rear wall 4, inner surface 5(b) of the right wall 5, and the outer surface 3(a) of the left wall 3.

FIG. 1A also displays the upper curvilinear bends 24, 28 of the left S-bracket 23 (not in view) and right S-bracket 27 (not in view). In a different embodiment, the waste receptacle 1 may comprise only one pivotable lid.

The two pivotable lids 8, 9, may be open, fully closed, or partially closed by virtue of their rotational movement about the horizontal retaining rod 16. The retaining rod 16 is inserted and contained securely in place, through co-axial orifices 13(a), 15(a), 14(a). These orifices are permanently attached to the left outer wall 3(a), rear ledge 20, and right outer wall 5(a), respectively. The front wall 2 of the multiple-purpose waste receptacle 1 is constructed at a rearward-sloping angle relative to the vertical, as illustrated.

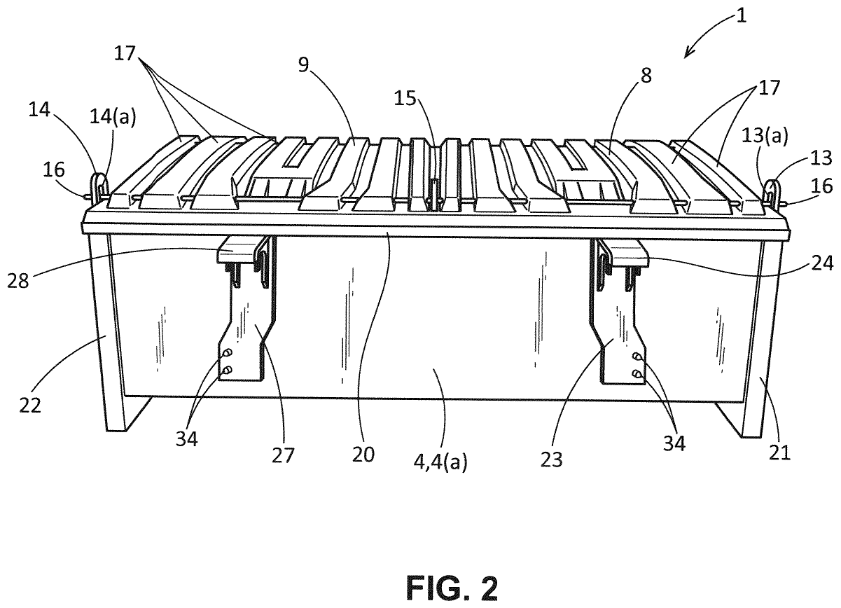

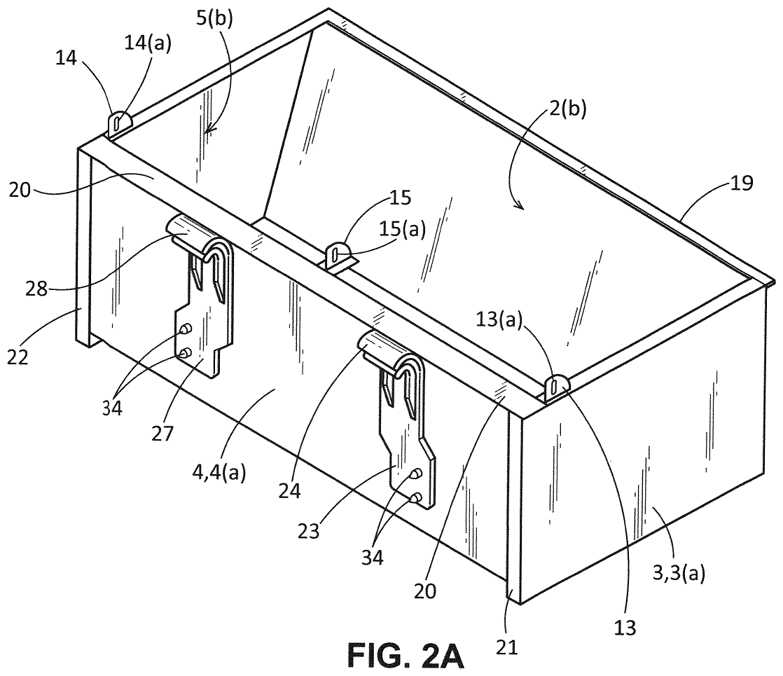

FIG. 2 displays a rear view of the entirety of an embodiment of the waste receptacle 1, including the arrangement of structural ribs 17, 18, which serve to strengthen the left and right pivotable lids 9, 8. Further shown are the rear ledge 20, the right rear stanchion 22 and left rear stanchion 21. A right S-bracket 27 and a left S-bracket 23 are shown, both of these brackets attached permanently to the rear outer wall 4, 4(a). Each S-bracket 27, 23 is constructed having a curvilinear bend 28, 27, respectively, at the uppermost extent of the length of each S-bracket 27, 23.

Further shown, in FIG. 2, are the retainer lugs 13, 15, 14 which provide support for the retaining rod 16, further enabling rotation of the pivotable lids 9, 8. (not shown) which retaining rod 16 fits within concentric orifices 13(a), 15(a), 14(a).

The curvilinear bends 28, 24 serve to simultaneously accept, within the inner surface of each curvilinear bend 28, 24, horizontal positioning of a linear rod (not shown) component of a John Deere® S-hook connector, or similar type industrial connectors commonly available. FIG. 2A provides illumination of the structure of the right S-bracket 27 and left S-bracket 23 and the positioning of the respective curvilinear bends 28, 24. The right S-bracket 27 and left S-bracket 23, collectively, comprise an embodiment of a detachable attachment mechanism affixed to the multi-purpose waste assembly 1.

In referring to FIG. 2A, there is shown an isometric rear view of the waste receptacle 1 with the left pivotable lid 8, right pivotable lid 9, and the retaining rod 16 having been removed. The left retainer lug 13, center retainer lug 15, and right retainer lug 14 are shown and the rearward-slanted front inner wall 2(b) is noticeable. Also shown are the right inner wall 5(b), a partial view of the floor 7, the outer surface 4(a) of the rear wall, and the outer left wall 3(a). The right S-bracket 27 and the left S-bracket 23 are also in view.

In FIG. 2A, proximate the lower end of each S-bracket 27, 23, are displayed two alignment/attachment pins 34. When the waste receptacle 1 is in a securable position relative to an S-hook connector 33 (not shown) clevis pins must be inserted through each alignment/attachment pin 34 to secure the hook connector, or other mechanism, to the right and left S-brackets 27, 23, respectively.

This procedure enables securement of the waste receptacle 1 to a John Deere© S-hook connector 33, or similar connector apparatus attached to a tractor boom, loader, or other similar mechanical lifting vehicle. In this manner, a driver of a tractor 31 equipped with a front boom 32 and S-hook connector is able to engage both upper curvilinear bends 24, 28 onto a particular type of connector 33, lift the waste receptacle 1 vertically, and subsequently lift it and/or transport it to a desired location.

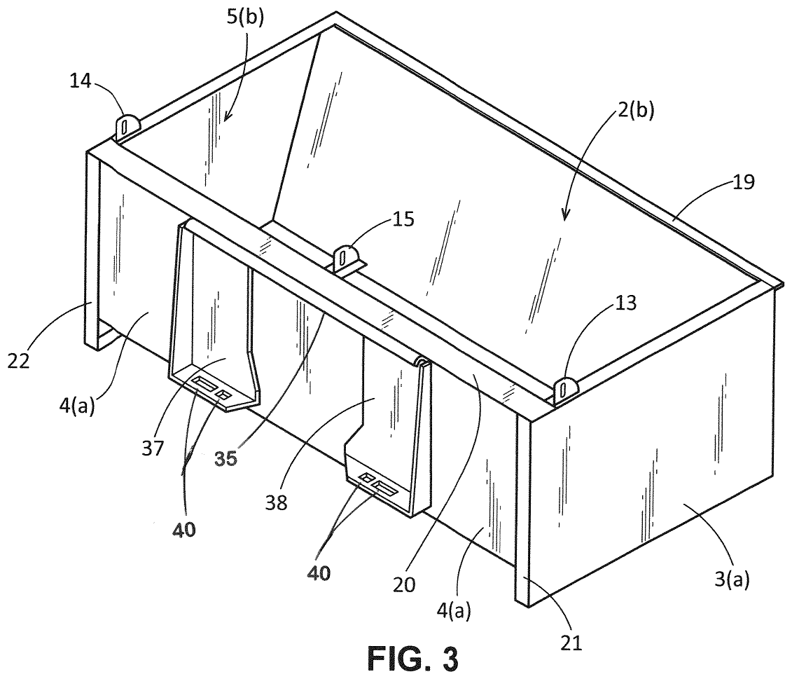

FIG. 3 depicts a second embodiment of the multi-purpose waste receptacle 1. The left pivotable lid 8, right pivotable lid 9, and the retaining rod 16 have been omitted from FIG. 3. Permanently attached to the rear outer wall 4(a) is an attachment mechanism comprising a horizontal beam 35 having permanently affixed, at its outer ends, a right vertical brace 37 and a left vertical brace 38. The attachment mechanism is positioned so as to coordinate with the structure and dimensions of an implement referred to as a “skid steer” quick connect. Two differently-sized slots 40 are utilized to secure the connection to an S-hook connector. The horizontal beam 35, right vertical brace 37, and left vertical brace 38 collectively, comprise an embodiment of a quick-attach assembly affixed to the multi-purpose waste assembly 1.

The skid steer device is commonly manufactured by companies such as Kubota®, John Deere®, Bobcat®, and the device may be easily attached to a tractor boom 32 or other mechanical lifting vehicle. As it becomes necessary to lift the shown embodiment of the waste receptacle 1, a skid steer device is functionally positioned to engage the inner surfaces of the right and left vertical braces 37, 38 and thereby enable the coupled boom 32 of a tractor 31 or similar mechanical lifting vehicle to lift the waste receptacle 1.

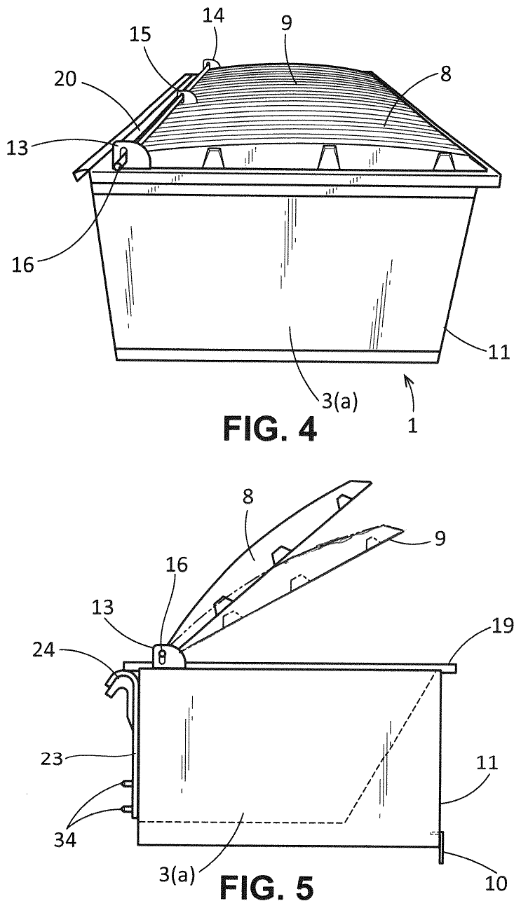

FIG. 4 presents a left-side view of the waste receptacle 1, further showing the left outer wall 3(a), with both the left pivotable lid 8 and the right pivotable lid 9 in their closed positions. The leftmost end of the retaining rod 16 is shown as it fits into the orifice 13(a) of the left retainer lug 13, continuing through the center retainer lug 15 and right retainer lug 14.

FIG. 5 displays a side view of the waste receptacle 1, showing the left outer wall 3(a), the left pivotable lid 8 and right pivotable lid 9 both partially open. Also in view is the left edge of the left S-bracket 23, including its left curvilinear bend 24 and the two lower alignment/attachment pins 34. The front ledge 19 serves as the frontward resting point of both pivotable lids 8, 9, when they are fully closed. The left end of the retaining rod 16 is in view, being enclosed within the orifice of the left retainer lug 13. Further, the leftmost end of the width-wise rake 10 is in view.

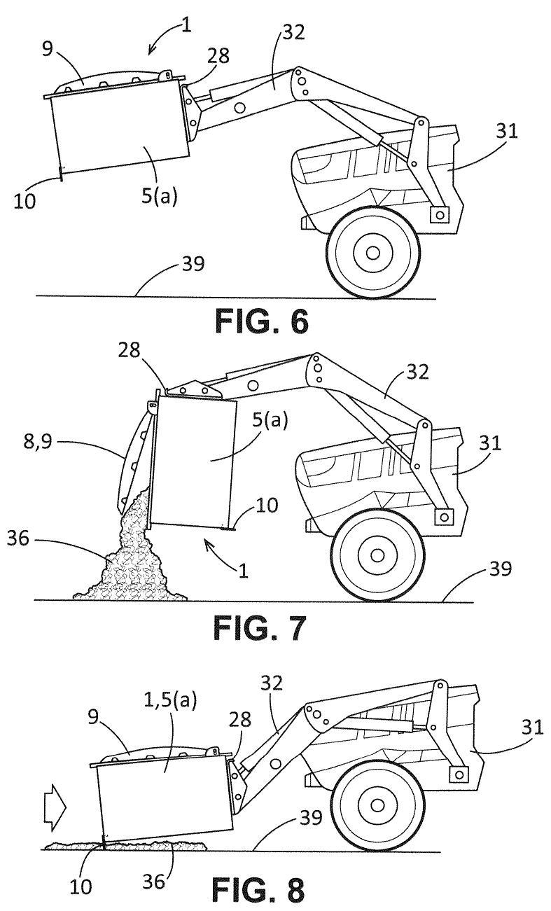

FIG. 6 illustrates an embodiment of the waste receptacle 1, containing waste 36, or other content, having been lifted vertically by virtue of the waste receptacle 1 being securely attached to an S-hook connector 33 (out of view). The S-hook connector 33 is secured within the inner surface of both the right curvilinear bend 28 of the right S-bracket 27 and the left curvilinear bend 24 of the left S-bracket 23 (not in view). The S-hook connector 33 has priorly been attached to the boom 32 of the front end of a tractor 31, as shown.

FIG. 7 is a continuing sequence of operation of the waste receptacle 1 shown in FIG. 6. The S-hook connector 33, by manipulation of the boom 32 and S-hook connector 33 is maneuvered to position the front end of the waste receptacle 1 in a downward tilt. This position, in turn, causes the pivotable lids 8, 9 to partially open and disgorge the contents of the waste receptacle 1 onto the ground 39.

FIG. 8 displays the tractor boom 32 utilized to operate the waste receptacle 1 so as to engage its width-wide rake 10 to force distribution of the waste 36, or other content, onto the ground surface 39 or other general area of depositing content of the waste receptacle 1.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. A multi-purpose waste receptacle having a vertically-slanted front wall, a left wall, a right wall, and a rear wall, the vertical edges of the walls sequentially joined to each other orthogonally and mutually joined, at their respective bottom edges, to a common floor; at least one ribbed lid pivotable about a retainer rod atop the rear wall; a rake attached horizontally the width of the waste receptacle, proximate the lower front wall of the receptacle; and the multi-purpose waste receptacle further having a means for detachably coupling the waste receptacle to a tractor boom, loader, or other similarly-functioning mechanical lifting vehicle.

2. The multi-purpose waste receptacle of claim 1, wherein the means for detachably coupling the waste receptacle to a tractor boom, loader, or other similarly-functioning mechanical lifting vehicle comprises an attachment mechanism being (a) a right S-bracket 27 attached proximate the right side of the outer surface of the rear wall (b) a left S-bracket 23, attached proximate the left side of the outer surface of the rear wall, (c) both S-brackets symmetrically spaced apart horizontally and both having attachment/alignment pins, and further, (d) both S-brackets culminating in an outwardly curvilinear bend at the uppermost extent of each respective S-bracket, thereby enabling detachable coupling to an S-hook type connector.

3. The multi-purpose waste receptacle of claim 1, wherein the means for detachably coupling the waste receptacle to a tractor boom, loader, or other similarly-functioning mechanical lifting vehicle comprises an attachment mechanism further comprising a horizontal beam having integrally affixed, at its outer ends, the upper end of a right vertical brace and a left vertical brace, each brace having lowermost slots, the attachment mechanism being permanently joined to the outer rear wall of the waste receptacle, thereby enabling detachable coupling of the attachment mechanism to the structure and dimensions of a “skid steer” quick connect.

4. A multi-purpose waste receptacle comprising (a) a left, vertically-oriented planar wall, (b) a rear, vertically-oriented planar wall, (c) a right, vertically-oriented planar wall, (d) a rearwardly-slanted planar front wall, wherein the bottom edge of each wall is permanently joined to (e) a horizontally-oriented planar floor; (f) at least one ribbed planar lid pivotable about a retainer rod attached atop the rear wall; (g) a horizontally-oriented rake, permanently attached to the lower front edges of the left wall and right wall, and (h) a means for detachably coupling the multi-purpose waste receptacle to a tractor boom, loader, or other similarly-functioning mechanical lifting vehicle.

5. The multi-purpose waste receptacle of claim 4, wherein the means for detachably coupling the waste receptacle to a tractor boom, loader, or other similarly-functioning mechanical lifting vehicle comprises an attachment mechanism being (a) a right S-bracket 27 attached proximate the right side of the outer surface of the rear wall (b) a left S-bracket 23, attached proximate the left side of the outer surface of the rear wall, (c) both S-brackets symmetrically spaced apart horizontally and both having attachment/alignment pins, and further, (d) both S-brackets culminating in an outwardly curvilinear bend at the uppermost extent of each respective S-bracket, thereby enabling detachable coupling to an S-hook type connector.

6. The multi-purpose waste receptacle of claim 4, wherein the means for detachably coupling the waste receptacle to a tractor boom, loader, or other similarly-functioning mechanical lifting vehicle comprises an attachment mechanism further comprising a horizontal beam having integrally affixed, at its outer ends, the upper end of a right vertical brace and a left vertical brace, each brace having lowermost slots, the attachment mechanism being permanently joined to the outer rear wall of the waste receptacle, thereby enabling detachable coupling of the attachment mechanism to the structure and dimensions of a “skid steer” quick connect.
